(19) United States
(12) Patent Application Publication
(10) Pub. No.: US 2010/0035487 A1
(43) Pub. Date: Feb. 11, 2010

(54) TERMINAL FITTING AND A WIRE CONNECTED WITH A TERMINAL FITTING

(75) Inventors: Junko Nakagawa, Yokkaichi-City (JP); Mitsugu Furutani, Yokkaichi-City (JP); Yoshihiro Mizutani, Yokkaichi-City (JP); Tomohiko Kobayashi, Yokkaichi-City (JP)

Correspondence Address: CASELLA & HESPOS, 274 MADISON AVENUE, NEW YORK, NY, 10016, US

(73) Assignee: Sumitomo Wiring Systems, Ltd., Yokkaichi-City (JP)

(21) Appl. No.: 12/509,643

(22) Filed: Jul. 27, 2009

(30) Foreign Application Priority Data
Aug. 8, 2008 (JP) 2008-205511
Sep. 12, 2008 (JP) 2008-235506
Sep. 16, 2008 (JP) 2008-236683

(51) Int. Cl. H01R 4/18

(52) U.S. Cl. 439/877

(57) ABSTRACT

A terminal fitting (1, 110, 111, 210) is provided with a wire barrel (4, 131, 231) to be crimped into connection with a core (7, 142, 242) made of a plurality of metal strands and exposed at a leading end portion of a wire (W, 140, 240), and an inner conductive portion (9-12, 134, 135, 235) connected with a wall surface of the terminal fitting (1, 110, 111, 210) and to be held in electrical contact with the metal strands by extending into the inside of the core (7, 142, 242) at an inner side of the wire barrel (4, 131, 231) crimped into connection with the core (7, 142, 242).

### BACKGROUND OF THE INVENTION

1. Field of the Invention

The invention relates to a terminal fitting, a wire connected with a terminal fitting and to a connecting method therefor.

2. Description of the Related Art

U.S. Pat. No. 7,306,495 and Japanese Unexamined Patent Publication No. 2003-249284 each disclose a terminal fitting with a wire barrel that can be crimped into connection with a core exposed by stripping off insulation from an end portion of a wire. Thus, a conductive region of the terminal fitting and the wire core is an outer circumferential portion of the core held in close contact with the inner surface of the wire barrel. However, the outer circumferential surface of the core is subject to external influences, such as water. As a result, conductivity stability may decrease with time.

A thick wire typically has a core made of more metal strands, and hence pressure from a wire barrel is distributed more easily. However, the wire barrel does not contact strands at radially inward positions of the core and films remain on the radially inwardly strands. Thus, electrical connection is not established with the radially inwardly located strands, contact resistance increases and conductivity stability may decrease.

The invention was developed in view of the above situation and an object thereof is to provide a terminal fitting capable of improving conductivity stability with a wire.

### SUMMARY OF THE INVENTION

The invention relates to a terminal fitting with at least one wire barrel to be crimped, bent or folded into connection with a core made of metal strands that are exposed at a leading end portion of a wire. At least one inner conductive portion is connected with a wall surface of the terminal fitting and extends into a portion of the core crimped in the wire barrel for electrically contacting the metal strands. The wire barrel is crimped into close contact with an outer circumferential portion of the core to ensure an outer surface conductive region. Further, the inner conductive portion extends into the inside of the core to ensure an inner conductive region. Thus, the conductive function is maintained reliably at the inner side, which is unlikely to be subject to external influences, even if a conductive function at the outer surface is decreased by an external influence.

The inner conductive portion scrapes off or breaks films formed on the outer surfaces of the metal strands inside the core as the wire barrel is crimped into connection with the core. Thus, the inner conductive portion is brought into electrical contact with the metal strands that have the films scraped off or broken. Accordingly, contact resistance is reduced by establishing an electrical connection with the metal strands inside the core that are not in contact with the wire barrel. Thus, the terminal fitting improves conductivity stability with a wire.

The inner conductive portion may be integral or unitary with the terminal fitting to simplify the structure of the terminal fitting.

One end of the inner conductive portion may be connected with a wall of the terminal fitting and an opposite end may extend to a central part of the core to define a conductive region in a deep part of the core that will not be subject to external influences.

The inner conductive portion may be cantilevered from a wall of the terminal fitting so a free end thereof is held in contact with the metal strands in the core. Thus, the inner conductive portion can be formed easily.

The wire barrel includes at least one barrel piece and the inner conductive portion preferably includes a coupling that projects from an edge of the barrel piece. A conductive portion preferably bulges out substantially along a longitudinal direction of the terminal fitting from the coupling. The inner conductive portion is formed at the edge of the barrel piece and can be guided to the inside of the core as the barrel piece is crimped into connection with the core. Further, the inner conductive portion and the edge of the barrel piece are connected via the narrow coupling. Thus, a water intrusion path along the barrel piece is narrow.

The inner conductive portion may extend from a position before the leading end of the core toward a central part of the interior of the wire barrel. The disposition of an end of the inner conductive portion forward from the wire barrel ensures increases the length of the inner conductive portion inside the core. Therefore, a long creepage distance exists for water or the like to reduce external influences even more.

The wire barrel may include two barrel pieces standing up from opposite sides of a bottom wall on which the core is placed. The inner conductive portion may be bent from the front edge of the barrel piece that is closer to the leading end of the core and may extend toward the other barrel piece. Accordingly, the inner conductive portion moves into the core as the barrel pieces are crimped. Therefore, the inner conductive portion is arranged inside the core even in the case of reducing a cross-sectional area of the bundle of the metal strands by increasing a compression ratio of a crimping portion.

The wire barrel may include a standing wall that stands up from a leading end of a bottom wall on which the core is placed and at a position before the leading end of the core. The inner conductive portion may extend from a lateral edge of the standing wall toward the core. Accordingly, the inner conductive portion can extend lateral to the standing wall prior to forming the terminal fitting and hence can be longer in conformity with a dimension of the wire barrel in forward and backward directions. Therefore, a contact area of the metal strands and the inner conductive portion can be increased.

Two inner conductive portions may be arranged substantially facing each other. Thus, the pair of inner conductive portions are more easily insertable into the bundle of the metal strands as the crimping operation is performed.

The at least one inner conductive portion may be formed separately from the terminal fitting. Accordingly, existing terminal fittings can be utilized.

The inner conductive portion may be an electrically conductive metal plate that is pressed into the inside of the core while facing a bottom wall on which the core is placed. Thus, the inner conductive portion is more easily insertable into the bundle of the metal strands and the opposite sides of the inner conductive portion can be held in contact with the inner circumferential surface of the wire barrel.

The wire barrel may include barrel pieces standing up from opposite sides of a bottom wall on which the core is placed. Leading ends of the barrel pieces are inserted into the bundle of the metal strands by a crimping operation and contact an intermediate part of the inner conductive portion. Accordingly, the leading ends of the barrel pieces can be brought into contact with the middle part of the inner conductive portion.

Recesses may be formed in a crimping surface of the wire barrel. The core may engage in the recesses for fastening the core. Further, recesses may be formed in both sides of the inner conductive portion. Then, the metal strands bite in the recesses during crimping and opening edges of the recesses scrape off the films formed on the outer surfaces of the core to establish an electrical connection.

The core may be made of a material different from copper or copper alloy and having a higher rigidity, such as aluminum or aluminum alloy.

These and other objects, features and advantages of the present invention will become more apparent upon reading of the following detailed description of preferred embodiments and accompanying drawings. It should be understood that even though embodiments are separately described, single features thereof may be combined to additional embodiments.

### BRIEF DESCRIPTION OF THE DRAWINGS

FIG. 1 is a side view in section showing a connected state of a terminal fitting and a wire according to a first embodiment.

FIG. 2 is a section along II-II of FIG. 1 likewise showing the connected state,

FIG. 3 is a diagram showing a clamp boundary layer.

FIG. 4 is a side view in section showing a connected state of a terminal fitting and a wire according to a second embodiment.

FIG. 5 is a section along V-V of FIG. 4 likewise showing the connected state.

FIG. 6 is a side view in section showing a connected state of a terminal fitting and a wire according to a third embodiment.

FIG. 7 is a side view in section showing a connected state of a terminal fitting and a wire according to a fourth embodiment.

FIG. 8 is a side view of a wire connected with a terminal fitting according to a fifth embodiment.

FIG. 9 is a section along A-A of FIG. 8.

FIG. 10 is a plan view showing inner conductive portions in a development state in the fifth embodiment.

FIG. 11 is an enlarged plan view showing the inner conductive portions in FIG. 10.

FIG. 12 is a plan view showing a bent state at first bending edges of FIG. 11.

FIG. 13 is a plan view showing a bent state at second bending edges of FIG. 12.

FIG. 14 is a section showing the inner conductive portion before crimping in the fifth embodiment.

FIG. 15 is a perspective view showing inner conductive portions in a sixth embodiment.

FIG. 16 is a plan view showing the inner conductive portions in a development state in the sixth embodiment.

FIG. 17 is a section showing a cross section of a wire connected with a terminal fitting according to the sixth embodiment at a position crossing the inner conductive portions.

FIG. 18 is a side view of a wire connected with a terminal fitting in a seventh embodiment.

FIG. 19 is an exploded perspective view of the wire connected with the terminal fitting of FIG. 18 before crimping.

FIG. 20 is a section showing a state before crimping where an inner conductive portion is inserted in a bundle of metal strands in the seventh embodiment.

FIG. 21 is a section showing a state after crimping where the inner conductive portion is inserted in the bundle of the metal stands in the seventh embodiment.

### DETAILED DESCRIPTION OF THE PREFERRED EMBODIMENTS

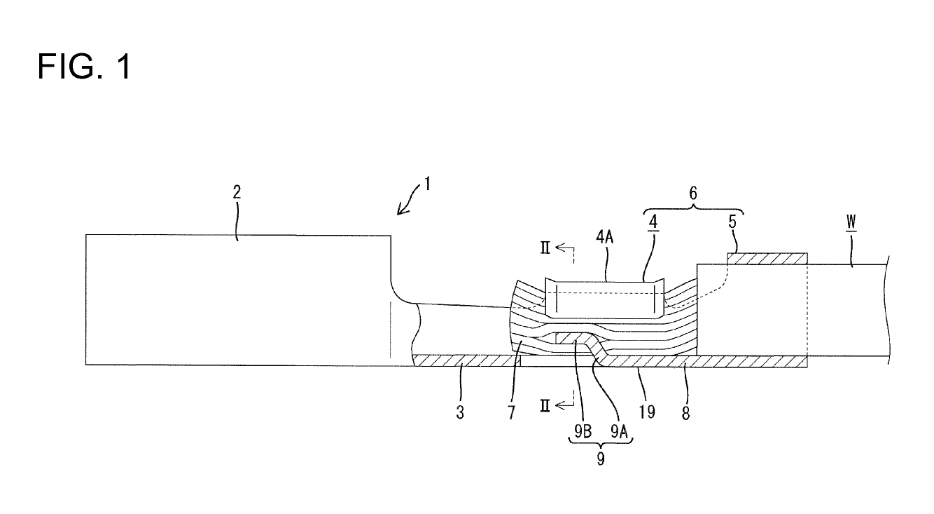

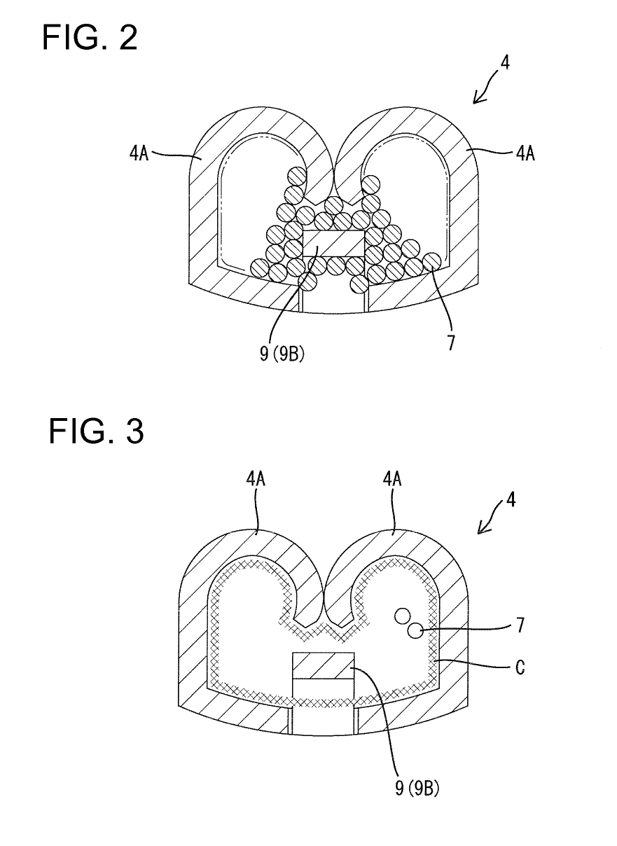

A first embodiment of the invention is described with reference to FIGS. 1 to 3. Identified by 1 in FIG. 1 is a female terminal fitting made of a flat plate material e.g. of a copper metal. A box portion 2 for connection with a mating terminal fitting is formed in a front portion of the female terminal fitting. A crimping portion 6 to be crimped, bent or folded into connection with a wire W is formed behind the box portion 2 via a connecting portion 3. The crimping portion 6 includes a wire barrel 4 and an insulation barrel 5 located one behind the other. The wire barrel 4 is to be crimped, bent or folded into connection with a core 7 exposed near an end portion of the wire W, and the insulation barrel 5 is to be crimped, bent or folded into connection with an insulated part of the wire. A coupling 8 is formed between the barrels 4 and 5. The core 7 is formed by twisting metal strands and surrounding the strands by a coating.

The wire barrel 4 includes two barrel pieces 4A projecting in a width direction from opposite lateral sides of a bottom wall 19 of the crimping portion 6. Leading end portions of the barrel pieces 4A are bent inwardly in a crimping step to be crimped strongly into connection with the core 7 while being caused to stand up. Thus, the wire barrel 4 and a clamp boundary layer C (cross-hatched region in FIG. 3) are located on an outer circumferential portion of the core 7. The clamp boundary layer C is an outer circumferential layer of the core 7 to be fastened by the wire barrel 4 and is substantially continuous in a circumferential direction from the inner surface of the wire barrel 4 to the inner surfaces of the leading ends of the both barrel pieces 4A.

A deep conductive piece 9 extends from the bottom wall 19 in the wire barrel portion 4. The deep conductive piece 9 is formed by making a cut in the bottom wall 19 and bending the cut portion with an intermediate part of the bottom wall 19 in the width and length directions as a base end to define a cantilever. More specifically, the deep conductive piece 9 includes a coupling 9A extending obliquely forward toward the box 2 from the base end and a conductive portion 9B extending substantially straight in a longitudinal direction from an end of the coupling 9A. The leading end of the conductive portion 9B is retracted back from the front end of the wire barrel 4, and the height thereof from the bottom wall 19 is in the range of about ¼ to about ¾ of the height of the fastened core 7, more preferably about half the height of the fastened core 7. In other words, the deep conductive piece 9 extends toward a central part of the fastened core 7, i.e. extends in a manner to bite into the clamp boundary layer C.

In this embodiment, the coupling 9A is narrower than the conductive portion 9B on the condition that necessary strength of the deep conductive piece 9 is ensured.

The terminal fitting of the first embodiment has a deep-side contact region A2 defined around the conductive portion 9B of the deep conductive piece 9 in the central part of the core 7 in addition to a surface-side contact region A1 (corresponding to the clamp boundary layer C) defined at a boundary between the inner circumferential surface of the wire barrel 4 and the outer circumferential portion of the core 7.

The first embodiment has several advantages. For example, electrolytic corrosion may occur between an aluminum wire and a terminal fitting made of copper. Electrolytic corrosion increases of contact resistance and must be avoided as much as possible. Electrolytic corrosion advances in the presence of water, and water intrusion is likely to influence areas of the terminal fitting in the surface-side contact region A1. Conversely, such influences are unlikely to appear in a deep part distant from the surface. Therefore the deep conductive piece 9 is protected from electrolytic corrosion and can obtain a good contact state for a long time. Of course, such an effect is notable in aluminum wires, but also is effective in avoiding the influence of rust resulting from water intrusion in copper wires.

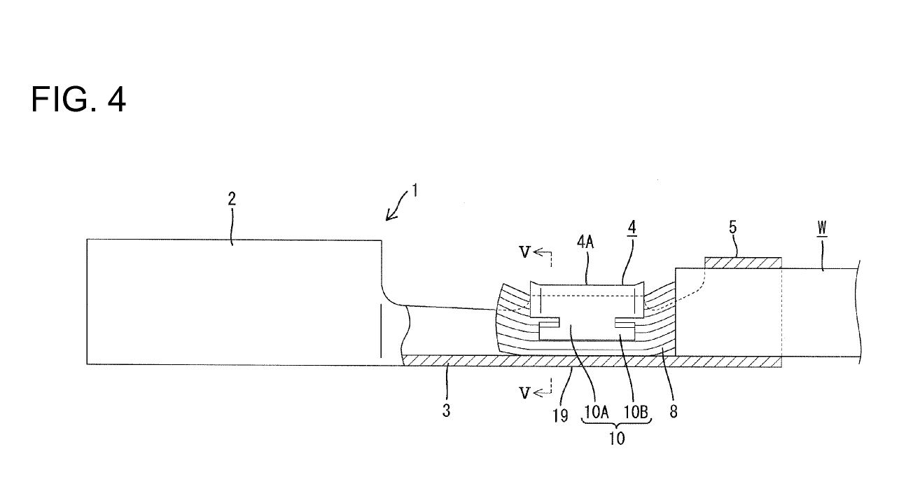

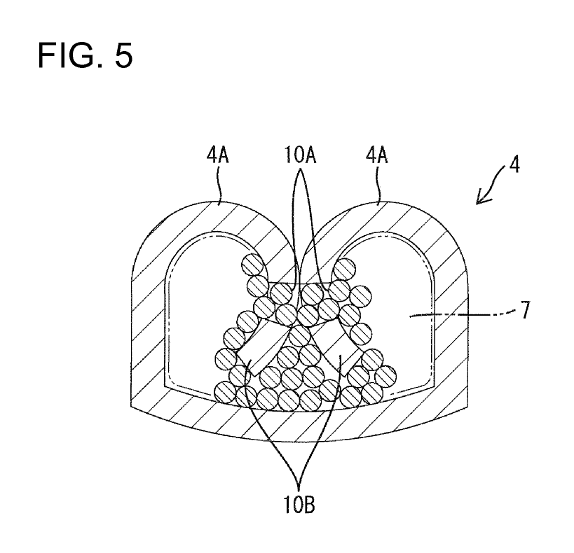

A second embodiment of the invention is described with reference to FIGS. 4 and 5. In the second embodiment, deep conductive pieces 10 are formed on one both barrel pieces 4A of a wire barrel 4. The deep conductive pieces 10 are unitary with longitudinal intermediate parts of the leading end edges of the barrel pieces 4A via narrow couplings 10A. The couplings 10A project at substantially right angles from the leading end edges of the barrel pieces 4A and bite into a clamp boundary layer C during crimping. The conductive portion 10B is formed at the leading end of each coupling 10A and bulges out in both forward and backward directions at an substantially right angles. However, the conductive portions 10B are present within the length range of the wire barrel 4 so as not to project out from the barrel 4 in the longitudinal direction.

The deep conductive pieces 10 are not affected by external influences and ensure a good contact state similar to the first embodiment. Two deep conductive pieces 10 are provided in a width direction to ensure the good contact state. Further, unlike the first embodiment, the bottom wall 19 has no opening and hence water is less likely to intrude into the terminal fitting. Also, the couplings are shorter than the conductive portions 10B. Therefore, water is not likely to intrude into the terminal fitting along the deep conductive pieces 10 and a good contact region is assured.

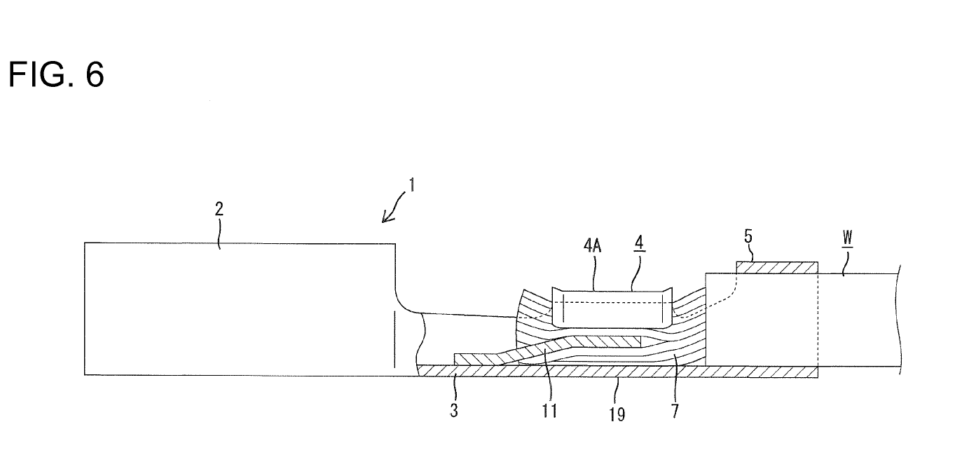

FIG. 6 shows a third embodiment of the invention. In this embodiment, the base end of a deep conductive piece 11 is arranged on a connecting portion 3 between the box 2 and the wire barrel 4 at a position before the leading end of a core 7. The deep conductive piece 11 has a base end fixed at this position preferably by welding or soldering, or by cutting and bending. The deep conductive piece 11 then extends obliquely back toward the interior of the wire barrel 4 and the center of a core 7 while biting into a clamp boundary layer C.

The third embodiment has functions and effects similar to the other embodiments. Additionally, the base end of the deep conductive piece 11 where water might intrude is located outside the wire barrel 4 to avoid water influences on the core 7.

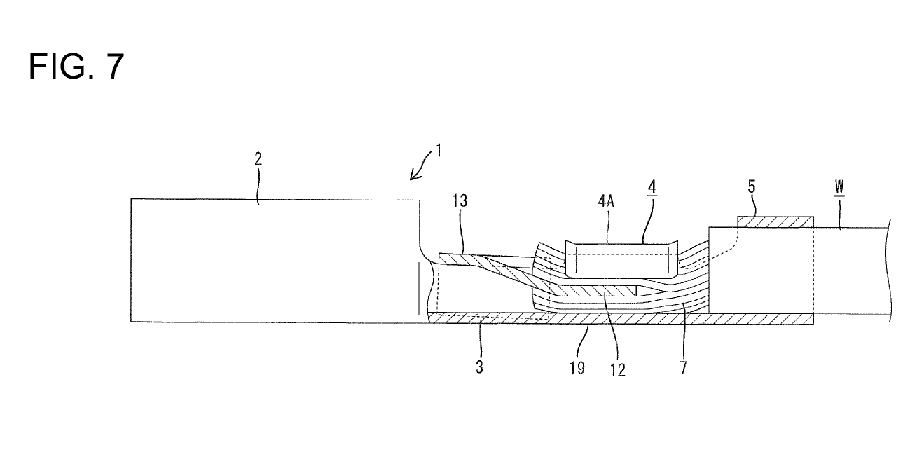

FIG. 7 shows a fourth embodiment of the invention. In this embodiment, a deep conductive piece 12 is formed separately from a terminal fitting. The deep conductive piece 12 is formed by cutting an upper surface of an inverted U-shaped clamp piece 13 that is mounted on a connecting portion 3 of the terminal fitting from above and bending the cut portion. The deep conductive piece 12 extends obliquely down toward a bottom wall 19 of the crimping portion 6 and toward the center of a core 7 in a wire barrel 4.

The clamp piece 13 of the fourth embodiment is mounted on the terminal fitting before the core 7 is fastened, thereby locating the deep conductive piece 12 in the wire barrel 4. The core 7 then is fastened.

The fourth embodiment exhibits functions and effects similar to those of the other embodiments. Additionally, the separate formation of the deep conductive piece 12 enables existing terminal fittings to be utilized.

The following embodiments also are included in the technical scope of the invention of the first to fourth embodiment.

Although the invention is described for female terminal fittings in the first to fourth embodiment, it also is applicable to male terminal fittings.

A separately formed deep conductive piece may be bonded, for example, by welding. Thus, no opening is formed in the bottom wall of the terminal fitting, and water intrusion into the terminal fitting can be avoided.

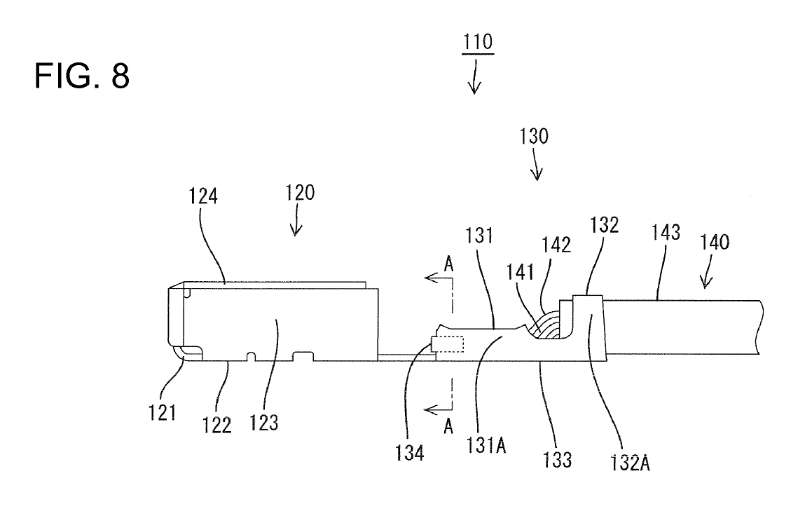

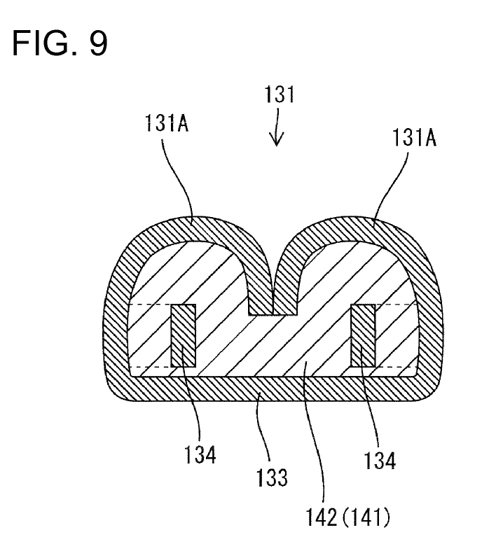

A fifth embodiment of the invention is described with reference to FIGS. 8 to 14. A terminal fitting 110 of this embodiment has a rectangular tubular main portion 120 and a crimping portion 130 formed behind the main portion 120, as shown in FIG. 8. The crimping portion 130 is crimped, bent or folded into connection with an end portion of a wire 140 and the wire 140 is draw out from the rear of the crimping portion 130, as shown in FIG. 9. The terminal fitting 110 is formed by punching or cutting a conductive metal plate made of copper alloy into a specified shape using a mold or press to form a flat blank for the terminal fitting 110 and then bending, folding and/or embossing the blank to form terminal fitting 110. Although the main portion 120 is illustrated as a female terminal fitting 110 in this embodiment, the terminal fitting 110 may be a tab-shaped male terminal fitting.

The wire 140 has a core 142 that is covered by a coating 143 made of an insulating synthetic resin. The wire 140 of this embodiment is a thick wire, specifically including a bundle of 37 metal strands 141, and a gross cross-sectional area of the bundle of these metal strands 141 is about 3 mm². The metal strands 141 can be an arbitrary metal, such as copper, copper alloy, aluminum or aluminum alloy, but preferably are an aluminum alloy.

The main portion 120 includes a bottom wall 122, two side walls 123 that project up from the opposite lateral edges of) the bottom wall 122, and a ceiling 124 formed by two walls placed one over the other, each by being bent at the top of one side wall 123 toward the top of the other side wall 123.

A resilient contact piece 121 is folded back from the front end of the bottom wall 122 and extends into the main portion 120. A substantially tab-shaped mating conductor (not shown) is insertable into the main portion 120 between the resilient contact piece 121 and the lower wall of the ceiling 124.

The distance between the resilient contact piece 121 in a natural state and the facing surface of the ceiling 124 is less than the thickness of the mating conductor. Thus, the mating conductor deforms the resilient contact piece 121 and achieves electrical connection with the resilient contact piece 121.

The crimping portion 130 includes a wire barrel 131 and an insulation barrel 132 arranged behind the wire barrel 131. The crimping portion 130 includes a bottom wall 133 continuous with the bottom wall 122 of the main portion 120 and extending substantially forward and backward along the longitudinal direction of the core 142.

The wire barrel 131 includes the bottom wall 133 and two barrel pieces 131A that project up from the opposite lateral edges of this bottom wall 133. The wire barrel 131 can be crimped, bent or folded into connection with the core 142 by placing an end portion of the core 142 on the bottom wall 133 and crimping the barrel pieces 131A into connection with the end portion of the core 142. Although not shown, serration, crenation or notching may be formed in the wire barrel 131, for example, by forming one or more grooves in a crimping surface for fastening the core 142.

The insulation barrel 132 includes the bottom wall 133 and two barrel pieces 132A that project up from the opposite lateral sides of the bottom wall 133. The insulation barrel 132 can be crimped, bent or folded into connection with the coating 143 and the core 142 by placing a part of the coating 143 on the bottom wall 133 and crimping the barrel pieces 132A into connection with the coating 143.

An insulating film (e.g. aluminum hydroxide, aluminum oxide, etc) may be formed on the outer surface of the core 142 e.g. by reaction with water and oxygen in air. Contact resistance increases if such a film present between the core 142 and the crimped wire barrel 131. Thus, a higher compression ratio is set than in the case of using a core made of copper alloy so that an electrical connection is established by scraping or breaking off the film.

Pressures from the barrel pieces 131A are distributed easily when the wire is thick and made of many metal strands 141, as in this embodiment. Thus, films are likely to remain on the radially inwardly located metal strands 141 that are not in contact with the barrel pieces 131A, and no electrical connection is established with these metal strands to increase the contact resistance. Therefore, the films need to be removed to establish an electrical connection with the radially inwardly located metal strands 141.

Accordingly, inner conductive portions 134 are cantilevered from the front edges of the barrel pieces 131A into the interior of the wire barrel 131. The inner conductive portions 134 are bent toward one another from the front edges of the respective barrel pieces 131A and then are bent again to extend backward. The inner conductive portions 134 are formed to contact the inside of the bundle of the metal strands 141 of the core 142 when the barrel pieces 131A are crimped. The front end of the bundle of the metal strands 141 substantially aligns with the front edges of the barrel pieces 131A so as not to interfere with the bent parts of the inner conductive portions 134.

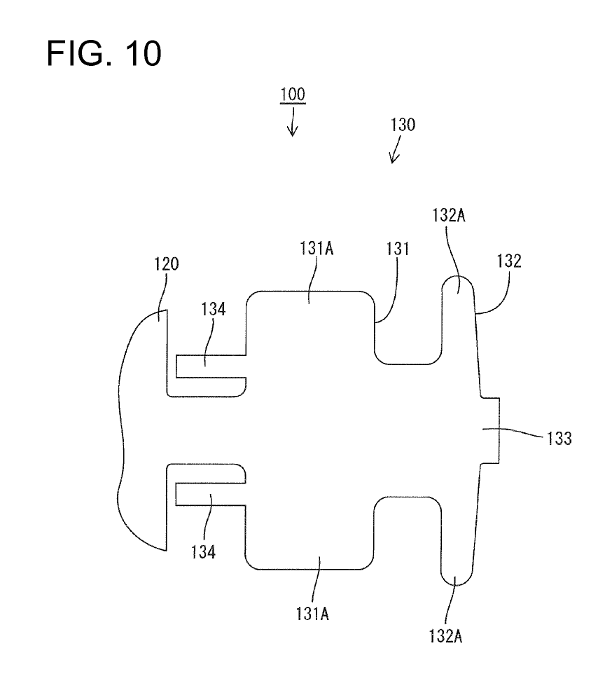

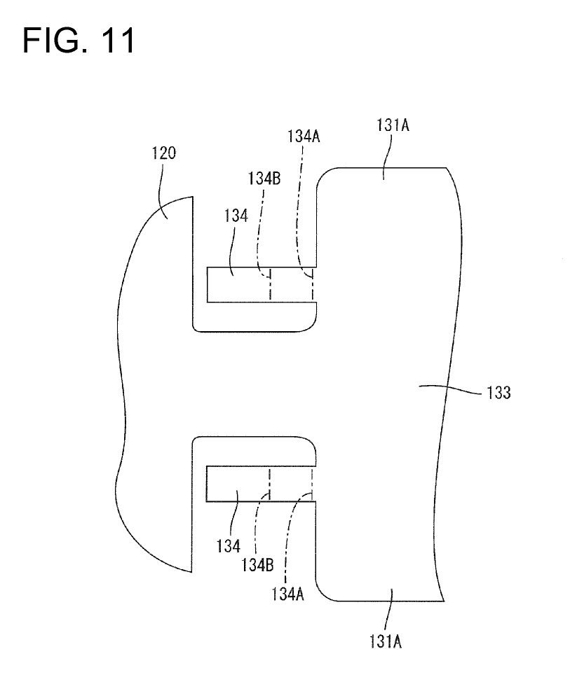

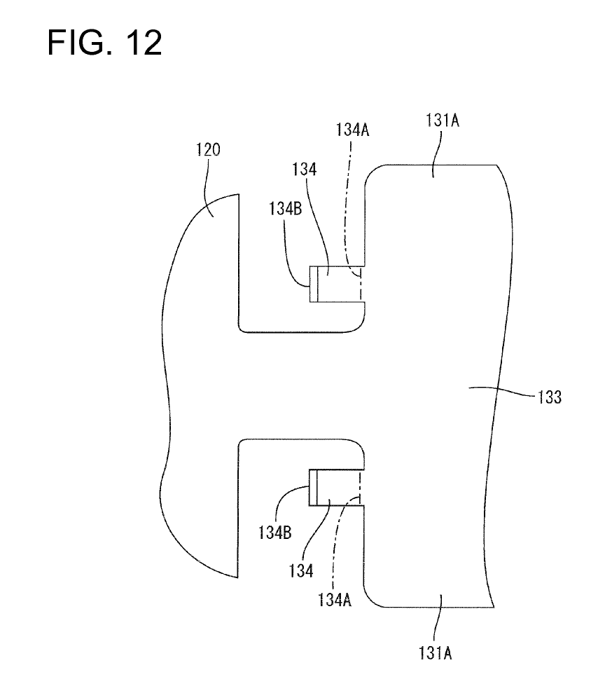

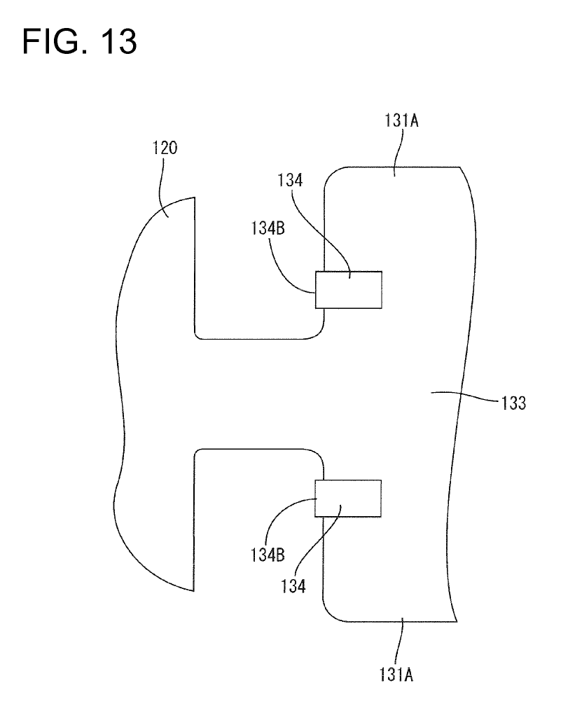

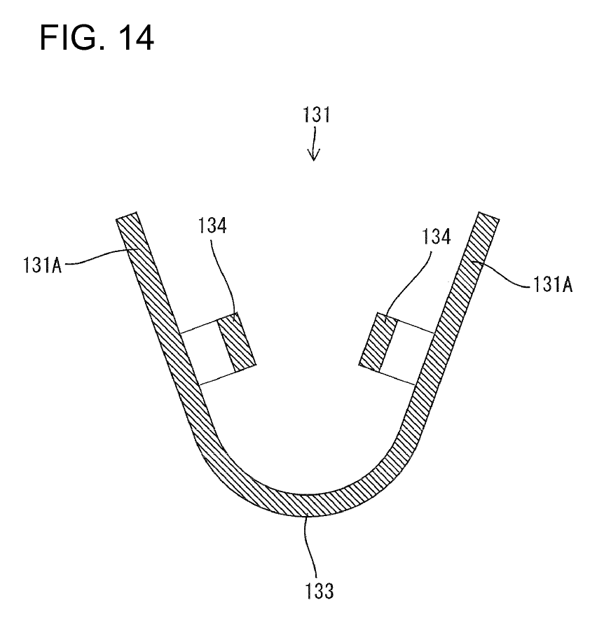

As shown in FIG. 10, the inner conductive portions 134 project forward from the front edges of the barrel pieces 131A on the planar blank that will be formed into the terminal fitting 110. The front ends of the inner conductive portions 134 are at positions so as not to interfere with the main portion 120. As shown in FIG. 11, the inner conductive portions 134 have first and second bending edges 134A and 134B in this order from the front edges of the barrel pieces 131A. The inner conductive portions 134 first are bent at the second bending edges 134B so that their leading ends extend up as shown in FIG. 12 and, then are bent at the first bending edges 134A so that their leading ends extend back, as shown in FIG. 13. Thereafter, the barrel pieces 131A are bent up until they face each other as shown in FIG. 14.

In this facing state, the barrel pieces 131A are spaced farther apart toward the upper side and the both inner conductive portions 134 are inclined. However, the barrel pieces 131A are brought closer together during the crimping process and the inner conductive portions 134 gradually become upright. Thus, the inner conductive portions 134 move into the bundle of the metal strands 141 as the barrel pieces 131A are crimped. Accordingly, the inner conductive portions 134 reliably enter the bundle of the metal strands 141 even though the cross-sectional area of the bundle of metal strands 141 becomes smaller as the barrel pieces 131A are crimped at a high compression ratio.

The inner conductive portions 134 stand up vertically and face each other as the barrel pieces 131A are crimped. Thus, the inner conductive portions 134 can be thrust more easily into the bundle of the metal strands 141. The barrel pieces 131A are crimped while the inner conductive portions 134 are in the bundle of the metal strands 141. Thus, the inner conductive portions 134 scrape or break off the films in the bundle of the metal strands 141 as shown in FIG. 9 and electrically contact the metal strands 141.

The connector 110 is used by initially stripping off the coating 143 at a front end portion of the wire 140 to expose the core 142. Subsequently, the end portion of the core 142 is placed on the bottom wall 133 of the wire barrel 131 and the coating 143 is placed on the bottom wall 133 of the insulation barrel 132. The crimping, bending or folding operation then is performed using a crimping apparatus (not shown). More particularly, the leading ends of the barrel pieces 131A, 132A are brought into contact with a crimper (not shown) and are bent inwardly. The inner conductive portions 134 come to face each other and move into the bundle of the metal strands 141 as the crimper is lowered further. The core 142 is fastened by the barrel pieces 131A when the crimper reaches a dead bottom center, as shown in FIG. 9. On the other hand, the coating 143 is fastened by the barrel pieces 132A of the insulation barrel 132. Substantially simultaneously, the rear end of the bottom wall 133 is cut by a slide cutter (not shown) to complete the connection of the wire with the terminal fitting.

The crimping operation presses the barrel pieces 131A against the radially outer metal strands 141 and scrapes off the films to achieve electrical contact between the barrel pieces 131A and the radially outer metal strands 141. The crimping operation also presses the inner conductive portions 134 against radially inner metal strands 141 and scrapes off the films to achieve electrical contact between the inner conductive portions 134 and the radially inner metal strands 141. Thus, the radially outer metal strands 141 and the radially inner metal strands 141 are connected electrically and the contact resistance is reduced. Further, water is unlikely to intrude into the core 142 so that the inner conductive portions 134 are protected maximally from electrolytic corrosion.

As described above, the wire 140 is thick, with a cross-sectional area of about 3 mm² and a large number of the metal strands 141. Accordingly, the number of radially inward metal strands 141 that might not contribute to the electrical connection also increases. However, the inner conductive portions 134 in this embodiment enable the radially inward metal strands 141 to contribute to the electrical connection and drastically increase the contact area of the electrically connectable metal strands 141. Thus, the contact resistance is reduced and conductivity stability is improved.

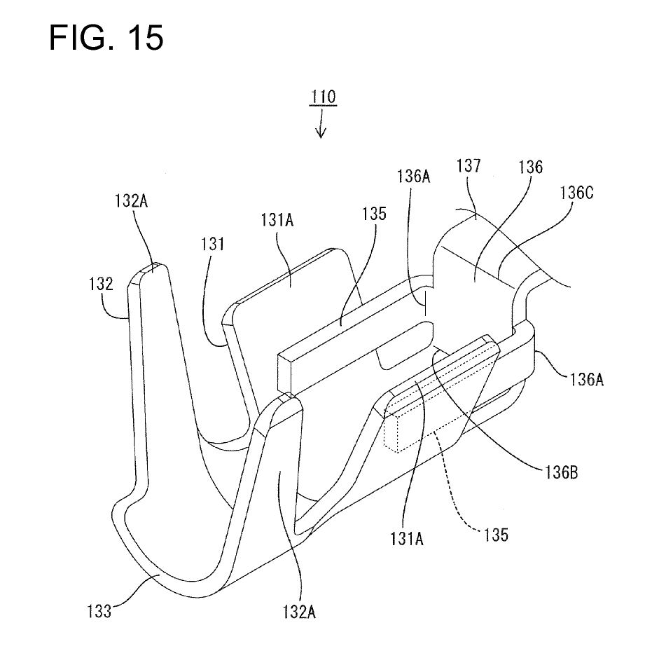

A sixth embodiment of the invention is described with reference to FIGS. 15 to 17. The terminal fitting 111 of the sixth embodiment differs from the fifth embodiment in the construction of inner conductive portions 134. Elements of the sixth embodiment that a re the same as or similar to the fifth embodiment are identified by the same reference numerals, but are not described again.

As shown in FIG. 15, inner conductive portions 135 of the sixth embodiment extend back from the opposite lateral sides of a standing wall 136 that projects up from the front end of a bottom wall 133. The top of the standing wall 136 is connected to a main portion 120 via a coupling 137. The inner conductive portions 135 extend more backward than the inner conductive portions 134 of the fifth embodiment. Thus, a larger contact area with the inside of a bundle of metal strands 141 can be obtained than.

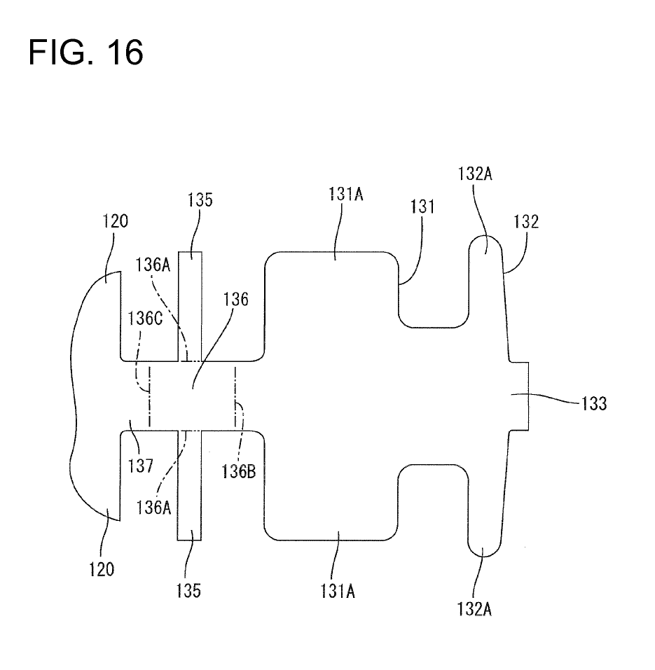

First bending lines 136A are set respectively between the inner conductive portions 135 and the opposite sides of the standing wall 136. A second bending line 136B is set between the front of the bottom wall 133 and the bottom of the standing wall 136 and a third bending line 136 is set between the coupling 137 and the upper edge of the standing wall 136. The inner conductive portions 135 are formed by bending the inner conductive portions 135 at the first bending lines 136A to extend up from a development state shown in FIG. 16, bending the standing wall 136 at the second bending line 136B to extend up and bending the coupling 137 at the third bending line 136C to extend forward.

Specifically, the inner conductive portions 135 of the planar blank extend laterally from the opposite lateral side of the standing wall 136 between the barrel pieces 131A and the main portion 120. Thus, the inner conductive portions 135 do not interfere with the main portion 120. Accordingly, the inner conductive portions 135 extend more laterally on the blank so that the rear ends of the inner conductive portions 135 align with the rear ends of the barrel pieces 131A after the bending process.

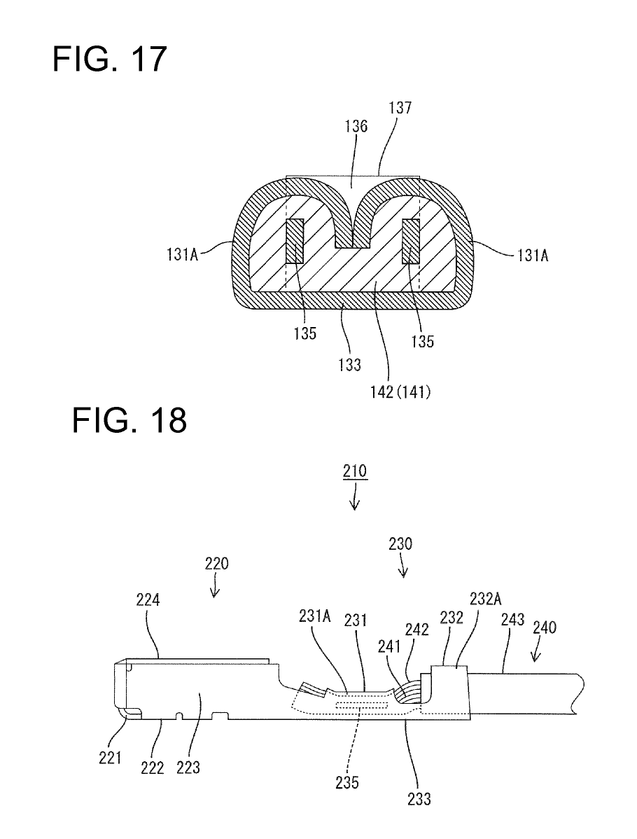

The inner conductive portions 135 are constantly in a standing state regardless of the crimping operation of the barrel pieces 131A. Thus, the inner conductive portions 135 can be arranged in the bundle of the metal strands 141 upon placing the end portion of the core 142 on the bottom wall 133. The barrel pieces 131A are crimped into connection with the bundle of the metal strands 141 with the inner conductive portions 135 arranged in the bundle of the metal strands 141. Thus, the inner conductive portions 135 scrape off or break the films in the bundle of the metal strands 141 and electrically contact the metal strands 141 having the films scraped off or broken, as shown in FIG. 17.

The inner conductive portions 135 are inserted more deeply into the bundle of the metal strands 141 in forward and backward directions in this embodiment than in the fifth embodiment. Thus, a contact area with the inside of the bundle of the metal strands 141 is increased and the contact resistance is reduced more than in the fifth embodiment.

The following embodiments also be included in the technical scope of the invention of the fifth and sixth embodiments.

The thick wire 140 has a cross-sectional area of 3 mm² in the fifth and sixth embodiments. However a wire having a different cross-sectional area may be used according to the invention, such as the following wires.

Aluminum wire 1 Size: 1.25 mm² (sixteen metal strands 141)

Aluminum wire 2 Size: 2 mm² (nineteen metal strands 141)

Aluminum wire 3 Size: 2.5 mm² (nineteen metal strands 141)

The inner conductive portions are flat plates in the fifth and sixth embodiments. However, the inner conductive portion may be accordion-shaped and extend back to increase the contact area with the inside of the bundle of the metal strands 141.

Two inner conductive portions are provided in the fifth and sixth embodiments. However, only one inner conductive portion may be provided or three or more inner conductive portions may be provided according to the invention.

The inner conductive portions 134 extend back by being bent at right angles twice from the front edges of the barrel pieces 131A in the fifth embodiment. However, the inner conductive portions 134 may be folded in a U-shape from the front edges of the barrel pieces 131A to extend back according to the invention.

The standing wall 136 stands up from the front edge of the bottom wall 133 in the sixth embodiment, but may stand obliquely upward toward the front from the front edge of the bottom wall 133. In such a case, the inner conductive portions 135 of the blank may extend obliquely back from the opposite lateral sides of the standing wall 136.

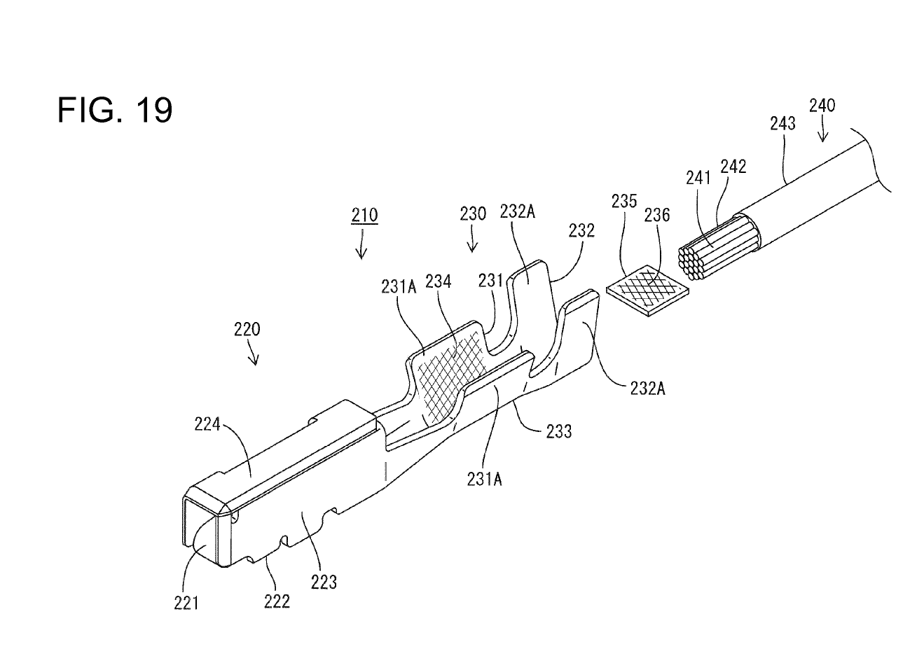

A seventh embodiment of the invention is described with reference to FIGS. 18 to 21. A terminal fitting 210 of this embodiment has a rectangular tubular main portion 220 and a crimping portion 230 formed behind the main portion 220, as shown in FIG. 18. The crimping portion 230 is crimped, bent or folded into connection with an end portion of a wire 240. The terminal fitting 210 is formed by punching or cutting a conductive metal plate e.g. made of copper alloy into a specified shape using a mold or stamp to form a planar blank for the terminal fitting 210 and then bending, folding and/or embossing the blank to form the terminal fitting 210 in the development state. Although the main portion 220 defines a female terminal fitting in this embodiment, the terminal fitting 210 may be a tab-shaped male terminal fitting according to the invention.

The wire 240 has a core 242 made of a plurality of metal strands 241 covered by a coating 243 made e.g. of an insulating synthetic resin. More particularly, the wire 240 is a thick wire including a bundle of 37 metal strands 241, and a gross cross-sectional area of the bundle of these metal strands 241 is about 3 mm². To simplify graphical representation, the total number of the metal strands 241 shown in FIGS. 18 to 20 is slightly less than an actual number (37). The metal strands 241 can be made of an arbitrary conductive material, such as copper, copper alloy, aluminum or aluminum alloy. However, the metal strands 241 of this embodiment preferably are an aluminum alloy.

The main portion 220 includes a bottom wall 222, two side walls 223 standing up from the opposite lateral sides of the bottom wall 222, and a ceiling 224 having two walls placed one over the other, each by being bent from the top of one side wall 223 toward the top of the other side wall 223.

A resilient contact piece 221 is folded back from the front of the bottom wall 222 into the main portion 220. A tab-shaped mating conductor (not shown) is insertable into the tubular main portion 220 between the lower surface of the ceiling 224 and the resilient contact piece 221, as in previous embodiments, to achieve electrical connection.

The crimping portion 230 includes a wire barrel 231 and an insulation barrel portion 232 behind the wire barrel 231. The crimping portion 230 includes a bottom wall 233 substantially continuous with the bottom wall 222 of the main portion 220 and extending forward and backward along longitudinal direction of the core 242.

The wire barrel 231 includes the bottom wall 233 and two barrel pieces 231A projecting from the opposite lateral sides of this bottom wall 233. The wire barrel 231 can be crimped, bent or folded into connection with the core 242 by placing an end portion of the core 242 on the bottom wall 233 and crimping the barrel pieces 231A into connection with the end portion of the core 242. Although not shown, serration or crenation or notching may be formed in the wire barrel 231, for example, by forming grooves in a crimping surface for fastening the core 242.

The insulation barrel 232 includes the bottom wall 233 and two barrel pieces 232A projecting from the opposite lateral sides of the bottom wall 233. The insulation barrel 232 can be crimped, bent or folded into connection with the coating 243 by placing a part of the coating 243 on the bottom wall 233 and crimping the barrel pieces 232A into connection with the part of the coating 243.

An insulating film (e.g. aluminum hydroxide, aluminum oxide, etc) may be formed on the outer surface of the core 242 e.g. by reaction with water and oxygen in air. Contact resistance increases if such a film present between the core 242 and the crimped wire barrel 231. Thus, a higher compression ratio is set than in the case of using a core made of copper alloy and serration, crenation or notching 234 is formed in a crimping surface of the wire barrel 231 in this embodiment. Thus, an electrical connection is established by scraping off or breaking the film. Accordingly, the serration 234 bites into the core 242 during the crimping operation and edges of the serration 234 scrape off or break the film to establish an electrical connection. The serration 234 preferably has a net-like structure and is obtained by forming grooves in directions oblique to the longitudinal direction of the core 242 in the crimping surface of the wire barrel 231.

Pressures from the barrel pieces 231A are distributed easily among the many metal strands of a thick wire. Thus, films are likely to remain on the radially inner metal strands 241 that are not in contact with the barrel pieces 231A. No electrical connection is established with these inner metal strands and contact resistance is high. Therefore, the films need to be removed to establish an electrical connection with the radially inner metal strands 241.

Accordingly, this embodiment has at least one inner conductive portion 235 provided separately from the wire barrel 231. The inner conductive portion 235 is inserted into the bundle of the metal strands 241 in an end portion of the core 242 inside the wire barrel 231 and the end portion of the core 242 having the inner conductive portion 235 inserted therein is fastened. As a result, the inside of the bundle of the metal strands 241 and the inner surfaces of both barrel pieces 231A are electrically connected via the inner conductive portion 235.

This inner conductive portion 235 is made of an electrically conductive material such as an electrically conductive metal plate of copper, copper alloy or the like. Thus, the inner conductive portion 235 can be inserted easily into the bundle of the metal strands 241 in the end portion of the core 242.

Serrations 236 are formed on both sides of the inner conductive portion 235 and have substantially the same shape as the serration 234 formed in the crimping surface of the wire barrel 231. The serrations 236 scrape off and break the films to establish an electrical connection with the metal strands 241. Therefore, the metal strands 241 are connected electrically with each other by the inner conductive portion 235.

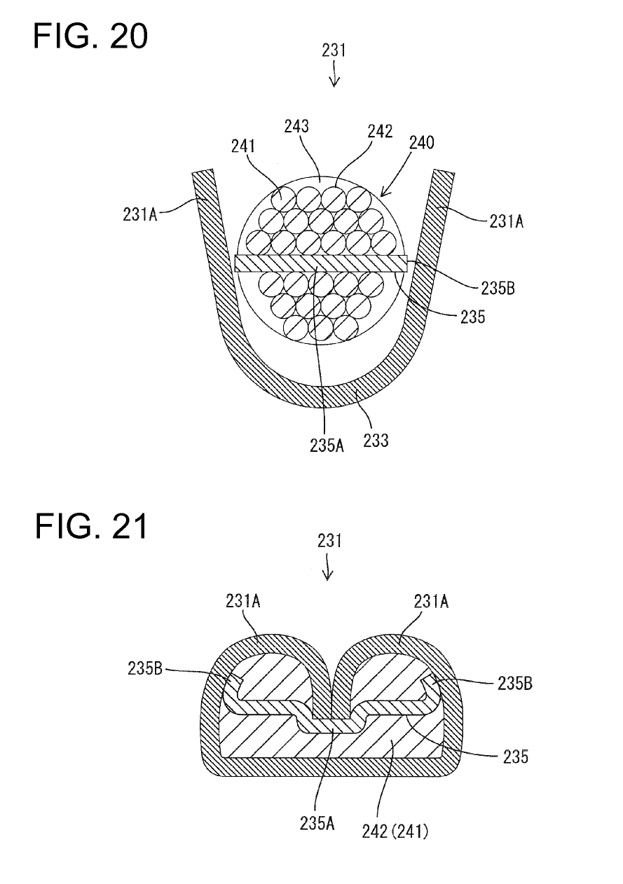

As shown in FIG. 20, the inner conductive portion 235 is inserted into the bundle of the metal strands 241 while facing the bottom wall 233. Thus, by crimping, bending or folding the barrel pieces 231A, the leading ends of the barrel pieces 231A are inserted into the bundle of the metal strands 241 to contact an intermediate part 235A of the inner conductive portion 235 as shown in FIG. 21. At this time, the middle part 235A of the inner conductive portion 235 is pressed by the leading ends of the barrel pieces 231A to be deformed down toward the bottom wall 233, thereby being electrically connected with the leading ends of the both barrel pieces 231A.

The barrel pieces 231A are crimped so that the lateral edges 235B of the inner conductive portion 235 contact the inner surfaces of the barrel pieces 231A as a distance between the barrel pieces 231A is narrowed. At this time, the opposite lateral edges 235B of the inner conductive portion 235 are deformed up upon receiving pressures from the inner surfaces of the barrel pieces 231A and electrically connect with the inner surfaces of the barrel pieces 231A. Accordingly, the radially inner metal strands 241 are connected electrically with the inner surfaces and leading ends of the barrel pieces 231A via the inner conductive portion 235. Therefore a contact area with the core 242 is increased and the contact resistance is reduced.

The coating 243 is stripped off the end of the wire 240 to expose the core 242. Subsequently, the inner conductive portion 235 is inserted into the bundle of the metal strands 241 and the end portion of the core 242 with the inner conductive portion 235 therein is placed on the bottom wall 233 of the wire barrel 231 and the coating 243 is placed on the bottom wall 233 of the insulation barrel 232, as shown in FIG. 20. The crimping operation then is performed using a crimping apparatus (not shown) so that the leading ends of the barrel pieces 231A, 232A are brought into contact with a crimper (not shown) and are bent in. The leading ends of the barrel pieces 231A of the wire barrel portion 231 are thrust into the bundle of the metal strands 241 and the barrel pieces 232A of the insulation barrel 232 are arranged along the outer circumferential surface of the coating 243. The core 242 is fastened by the barrel pieces 231A of the wire barrel 231, as shown in FIG. 21. On the other hand, the coating 243 is fastened together with the core 242. Substantially simultaneously or subsequently, the rear end of the bottom wall 233 is cut by a slide cutter (not shown) to complete the connection of the terminal fitting.

The crimping operation causes the serrations 234 of the barrel pieces 231A to scrape off or break the films on the radially outer metal strands 241 so that the barrel pieces 231A are connected electrically with the radially outer metal strands 241. On the other hand, the serrations 236 on the inner conductive portion 235 scrape off or break the films on the radially inner metal strands 241 so that the inner conductive portion 235 is connected electrically with radially inner metal strands 241. Further, the intermediate part 235A of the inner conductive portion 235 is connected electrically with the leading ends of the barrel pieces 231A, and the opposite lateral edges 235B of the inner conductive portion 235 are connected electrically with the inner surfaces of the barrel pieces 231A. In this way, the radially inner metal strands 241 are connected electrically with each other via the inner conductive portion 235 and are connected electrically with the inner surfaces and leading ends of the barrel pieces 231A via the inner conductive portion 235. Accordingly, the radially outer metal strands 241 and the radially inner metal strands 241 reliably achieve electrical connection. Additionally, the contact area with the core 242 is increased to reduce the contact resistance. Further, water is unlikely to intrude into the core 242 so that the inner conductive portion 235 is protected from electrolytic corrosion.

As described above, the radially inner metal strands 241 do not contact the barrel pieces 231A, but the serrations 236 of inner conductive portion 235 scrape off or break the films and connect electrically with the end of the core 242 as the wire 240 is fastened. More particularly, the thick wire 240 has a cross-sectional area of at least about 3 mm², and a large number of the metal strands 241. Accordingly, the number of the radially inner metal strands 241 not contributing to the electrical connection also increases. However, the inner conductive portion 235 contributes to the electrical connection of the radially inner metal strands 241. Thus, the contact area of the electrically connectable metal strands 241 is increased drastically, the contact resistance is reduced, and conductivity stability is improved.

The leading ends of the barrel pieces 231A contact the middle part 235A of the inner conductive portion 235, and the inner surfaces of the barrel pieces 231A and the opposite lateral edges 235B of the inner conductive portion 235 are brought into contact. Furthermore, the serrations 234, 236 the serrations 236 scrape off the films.

As for the seventh embodiment, the following embodiments can also be, for example, included in the technical scope of the present invention.

The inner conductive portion 235 is a substantially flat plate in the seventh embodiment. However, an accordion-shaped inner conductive portion 235 may be used to increase the contact area with the metal strands 241.

The metallic inner conductive portion 235 is used in the seventh embodiment. However, an inner conductive portion formed by plating the outer surfaces of a resin piece with an electrically conductive metal or an inner conductive portion formed by depositing an electrically conductive metal on the outer surfaces of a resin piece may be used.

Although the inner conductive portion 235 is held in contact with the inner surfaces of the both barrel pieces 231A in the seventh embodiment, a V-shaped inner conductive portion may be inserted into the bundle of the metal strands 241 and a bent end of the V-shape may be brought into contact with the inner surface of the bottom wall 233 according to the present invention.

Although the leading ends of the both barrel pieces 231A are pressed against the middle part 235A of the inner conductive portion 235 to deform the inner conductive portion 235 in the seventh embodiment, a through hole may be formed in the middle part 235A of the inner conductive portion 235 and the leading ends of both barrel pieces 231A may be inserted into this through hole to avoid the contact of the leading ends of the barrel pieces 231A and the inner conductive portion 235 according to the invention.

Although the serrations 234, 236 are formed in the crimping surface of the wire barrel portion 231 and the both sides of the inner conductive portion 235 in the seventh embodiment, it is not always necessary to form the serrations 234, 236 or only either the serration 234 or the serrations 236 may be provided according to the present invention.

Although one inner conductive portion 235 is inserted into the bundle of the metal strands 241 in the seventh embodiment, a plurality of inner conductive portions 235 may be inserted into the bundle of the metal strands 241 according to the invention.

Although the thick wire 240 having a cross-sectional area of 3 mm² is used in the seventh embodiment, the wire is not limited to this wire 240 and a wire having a different cross-sectional area may also be used according to the present invention. For example, the following wires may be cited as such.

Aluminum wire 1 Size: 1.25 mm² (sixteen metal strands 241)

Aluminum wire 2 Size: 2 mm² (nineteen metal strands 241)

Aluminum wire 3 Size: 2.5 mm² (nineteen metal strands 241)

What is claimed is:

1. A terminal fitting (1; 110; 110; 210), comprising:
at least one wire barrel (4; 131; 231) to be crimped into connection with a core (7; 142; 242) made of metal strands exposed at a leading end of a wire (W; 140; 240); and
at least one inner conductive portion (9-12; 134; 135; 235) connected with a wall of the terminal fitting and to be held in electrical contact with the metal strands by at least partly extending inside the core (7; 142; 242) at an inner side of the wire barrel (4; 131; 231) crimped into connection with the core (7; 142; 242).

2. The terminal fitting of claim 1, wherein the inner conductive portion (9-12; 134; 135) is unitary with the terminal fitting.

3. The terminal fitting of claim 1, wherein one end of the inner conductive portion (9-12; 134; 135) is connected with the wall of the terminal fitting and an opposite end thereof extends toward a central part of the core (7; 142; 242).

4. The terminal fitting of claim 1, wherein the inner conductive portion (9-12; 134; 135) is cantilevered from the wall of the terminal fitting so that a free end of the inner conductive portion (9-12; 134; 135) contact the metal strands in the core (7; 142; 242).

5. The terminal fitting of claim 1, wherein:
the wire barrel (4; 131; 231) has at least one barrel piece (4A; 131A; 231A); and
the inner conductive portion (9; 10) includes a coupling (9A; 10A) projecting from an edge of the barrel piece (4A) and a conductive portion (9B; 10B) bulging out substantially along a longitudinal direction of the terminal fitting from the coupling (9A; 10A).

6. The terminal fitting of claim 1, wherein the inner conductive portion (11; 12) extends from a position located before a leading end of the core (7) toward a central interior part of the wire barrel (4).

7. The terminal fitting of claim 1, wherein:
the wire barrel (131) includes front and rear barrel pieces (131A) standing up from opposite lateral sides of a bottom wall (133) on which the core (142) is to be placed; and
the inner conductive portion (134) extends from a front edge of the front barrel piece (131A) and is bent back toward the rear barrel piece (131A).

8. The terminal fitting of claim 1, wherein:
the wire barrel (131A) includes a standing wall (136) standing up from a leading end of a bottom wall (133) on which the core (142) is to be placed and at a position before the leading end of the core (142); and
the inner conductive portion (135) extends from a lateral edge of the standing wall (136) toward the core (142).

9. The terminal fitting of claim 1, wherein two inner conductive portions (9-12; 134; 135) are arranged facing each other.

10. The terminal fitting of claim 1, wherein the at least one inner conductive portion (235) is formed separately from the terminal fitting.

11. The terminal fitting of claim 10, wherein the inner conductive portion (235) is an electrically conductive metal plate inserted into the inside of the core (242) while substantially facing a bottom wall (233) on which the core (242) is to be placed.

12. The terminal fitting of claim 10, wherein:
the wire barrel (231) includes two barrel pieces (231A) standing up from opposite lateral sides of a bottom wall (233) on which the core (242) is to be placed; and
the leading ends of the barrel pieces (231A) are inserted into the bundle of the metal strands by a crimping operation and contact an intermediate part of the inner conductive portion (235).

13. The terminal fitting of claim 1, wherein a plurality of recesses (234; 236) are formed in a crimping surface of the wire barrel (4; 131; 231) and in both sides of the inner conductive portion (235).

14. A wire connected with a terminal fitting, comprising:
the terminal fitting (1; 110; 110; 210) of claim 1 crimped into connection with a core (7; 142; 242) made of a plurality of metal strands exposed at a leading end portion of a wire (W; 140; 240); and
the core (7; 142; 242) is made of a material different from copper or copper alloy having a higher rigidity.
